(19) United States
(12) Patent Application Publication
(10) Pub. No.: US 2026/0229970 A1
(43) Pub. Date: Aug. 6, 2026

(54) Integrated Assembly of a Gearbox and Electric Motor with Shared Cooling Features

(71) Applicant: Supernal, LLC, Washington, DC (US)

(72) Inventors: Siavash Sadeghi, Irvine, CA (US); Meagan Villanueva, Dallas, TX (US)

(21) Appl. No.: 19/149,587

(22) PCT Filed: Feb. 1, 2024
(86) PCT No.: PCT/US2024/014114

§ 371 Date: Jul. 21, 2025

Related U.S. Application Data
(60) Provisional application No. 63/443,701, filed on Feb. 6, 2023.

(51) Int. Cl. H02K 16/04; B64D 33/08; B64D 35/026; H02K 1/14; H02K 1/278; H02K 1/2791; H02K 5/20; H02K 7/08; H02K 7/116; H02K 15/40

(52) U.S. Cl. CPC H02K 16/04; B64D 33/08; B64D 35/026; H02K 1/146; H02K 1/278; H02K 1/2791; H02K 5/203; H02K 7/083; H02K 7/116; H02K 15/40

(57) ABSTRACT

An example assembly includes; an electric motor comprising: (i) at least one stator having a plurality of wire windings that generate a magnetic field, (ii) a rotor comprising a spindle and configured to interact with the magnetic field to cause the spindle to rotate, and (iii) at least one cooling jacket comprising a channel; a gearbox comprising (i) a gearbox housing mounted to the at least one cooling jacket of the electric motor, and (ii) at least one gear disposed within the gearbox housing, wherein the spindle extends within the gearbox housing to engage the at least one gear of the gearbox, wherein the gearbox contains fluid, such that the fluid circulates from the gearbox through the channel of the at least one cooling jacket; and a bearing disposed at least partially within the gearbox housing and configured to support the spindle.

### CROSS-REFERENCE TO RELATED APPLICATION

This application claims priority to U.S. Provisional Patent Application No. 63/443,701, filed on Feb. 6, 2023, the entire contents of which are hereby incorporated by reference.

### BACKGROUND

Many systems involving machinery or vehicles are being electrified. Particularly, electric motors are used to drive rotary components such as propellers, wheels, or any other rotary component.

An example system may include an electric power source (e.g., battery), an electric motor, and a gearbox driven by the electric motor. Typically, these components are separate. For instance, the electric motor is separate from the gearbox, but they are mechanically linked such that the motor drives the gearbox.

In such systems, it may be desirable to have highly-efficient, power dense, light-weight, and compact assemblies of components. To obtain such assemblies, it may be desirable to integrate the electric motor and the gearbox such that mechanical components (e.g., bearing, etc.) and cooling systems can be shared between the components of an assembly.

Due to space limitation in such an assembly, removal of heat from the assembly can be challenging. Traditional air cooling may be inadequate for the amount of heat removal that might be required in some applications. Particularly, there is typically not a lot of airflow in the tight spaces where an electric motor and gearbox may be located.

It may thus be desirable to configure a cooling system that enhances heat removal from such an assembly. It is with respect to these and other considerations that the disclosure made herein is presented.

### SUMMARY

The present disclosure describes implementations that relate to an integrated assembly of a gearbox and electric motor with shared cooling features.

In a first example implementation, the present disclosure describes an assembly. The assembly includes: an electric motor comprising: (i) at least one stator having a plurality of wire windings that generate a magnetic field when an electric current is provided therethrough, (ii) a rotor comprising a spindle and configured to interact with the magnetic field to cause the spindle to rotate, and (iii) at least one cooling jacket comprising a channel; a gearbox comprising (i) a gearbox housing mounted to the at least one cooling jacket of the electric motor, and (ii) at least one gear disposed within the gearbox housing, wherein the spindle of the rotor extends within the gearbox housing to engage and rotate the at least one gear of the gearbox as the spindle rotates, wherein the gearbox contains fluid, such that the fluid circulates from the gearbox through the channel of the at least one cooling jacket; and a bearing disposed at least partially within the gearbox housing and configured to support the spindle.

In a second example implementation, the present disclosure describes a vehicle. The vehicle includes: a propeller; an electric motor comprising: (i) at least one stator having a plurality of wire windings that generate a magnetic field when an electric current is provided therethrough, (ii) a rotor comprising a spindle and configured to interact with the magnetic field to cause the spindle to rotate, and (iii) at least one cooling jacket comprising a channel; a gearbox comprising (i) a gearbox housing mounted to the at least one cooling jacket of the electric motor, (ii) at least one gear disposed within the gearbox housing, wherein the spindle of the rotor extends within the gearbox housing to engage and rotate the at least one gear of the gearbox as the spindle rotates, and (iii) a gearbox output shaft coupled to the propeller, wherein the gearbox output shaft rotates as the spindle of the electric motor and the at least one gear of the gearbox rotate, wherein the gearbox contains fluid, such that the fluid circulates from the gearbox through the channel of the at least one cooling jacket; and a bearing disposed at least partially within the gearbox housing and configured to support the spindle.

In a third example implementation, the present disclosure describes a method. The method includes: providing an electric motor comprising: (i) at least one stator having a plurality of wire windings that generate a magnetic field when an electric current is provided therethrough, (ii) a rotor comprising a spindle and configured to interact with the magnetic field to cause the spindle to rotate, and (iii) at least one cooling jacket comprising a channel; providing a gearbox, wherein the gearbox comprises a gearbox housing and at least one gear disposed within the gearbox housing; mounting the gearbox housing to the at least one cooling jacket of the electric motor; extending the spindle of the rotor within the gearbox housing to engage and rotate the at least one gear of the gearbox as the spindle rotates, wherein the gearbox contains fluid, such that the fluid circulates from the gearbox through the channel of the at least one cooling jacket during operation of the electric motor; and mounting a bearing at least partially within the gearbox housing such that the bearing supports the spindle.

The foregoing summary is illustrative only and is not intended to be in any way limiting. In addition to the illustrative aspects, implementations, and features described above, further aspects, implementations, and features will become apparent by reference to the figures and the following detailed description.

### BRIEF DESCRIPTION OF THE FIGURES

FIG. 1 is a block diagram of a vehicle, according to exemplary embodiments of the present invention.

FIG. 2A illustrates a perspective view of an assembly of a gearbox and an electric motor, according to exemplary embodiments of the present invention.

FIG. 2B illustrates a side view of the assembly of FIG. 2A, according to exemplary embodiments of the present invention.

FIG. 2C illustrates a perspective cross-sectional view of the assembly of FIG. 1, according to exemplary embodiments of the present invention.

FIG. 2D illustrates a cross-sectional side view of the assembly of FIG. 1, according to exemplary embodiments of the present invention.

FIG. 3A illustrates a partial perspective view of an electric motor, according to exemplary embodiments of the present invention.

FIG. 3B illustrates a partial front view of the electric motor of FIG. 3A, according to exemplary embodiments of the present invention.

FIG. 4 illustrates a front view of a stator assembly having an outer stator and an inner stator, according to exemplary embodiments of the present invention.

FIG. 5A illustrates a simplified side view of a rotor assembly including a rotor of the electric motor of FIG. 3A, according to exemplary embodiments of the present invention.

FIG. 5B illustrates a front view of the rotor assembly of FIG. 5A, according to exemplary embodiments of the present invention.

FIG. 6 illustrates a front view of an electric motor configured as a reluctance motor according to exemplary embodiments of the present invention.

FIG. 7 illustrates a front view of an electric motor configured as a flux switching motor according to exemplary embodiments of the present invention.

FIG. 8 is a flowchart of a method for assembling a gearbox to an electric motor, according to exemplary embodiments of the present invention.

### DETAILED DESCRIPTION

Disclosed herein are assemblies of a gearbox integrated with a dual stator electric motor. The electric motor and the gearbox are integrated such that an output shaft or spindle of a rotor of the electric motor is supported by at least one bearing of the gearbox. In other words, the gearbox and the electric motor share components. Additionally, one or more cooling jackets of the electric motor is mechanically and fluidly coupled to the gearbox such that cooling fluid (i.e., oil) of the gearbox is provided to the electric motor to cool the electric motor.

As such, within example embodiments, disclosed herein is an assembly having an electric motor comprising: (i) at least one stator, (ii) a rotor comprising a spindle, (iii) at least one cooling jacket comprising a channel; a gearbox comprising (i) a gearbox housing mounted to the at least one cooling jacket of the electric motor, and (ii) at least one gear disposed within the gearbox housing, wherein the gearbox contains fluid, such that the fluid circulates from the gearbox through the channel of the at least one cooling jacket, wherein the spindle of the rotor extends through the gearbox housing to engage the at least one gear of the gearbox; and a bearing disposed at least partially within the gearbox housing and configured to support the spindle. With this configuration, a compact configuration where components and cooling circuits are shared between the gearbox and the electric motor.

The disclosed system may be utilized in any device or application that utilizes a motor. For example, the motor may be used to power or drive a vehicle, including but not limited to a ground vehicle (i.e., an automobile), a sea vehicle (such as a boat), or a flying craft (such as an aerial, floating, soaring, hovering, airborne, aeronautical aircraft, airplane, plane, spacecraft, a helicopter, an airship, or an unmanned aerial vehicle, a vertical take-off and landing (VTOL) craft, or a drone). The disclosed embodiments of the present invention may be utilized in any of these applications in order to obtain advantages such as compactness, light weight, enhanced power density, and higher efficiency.

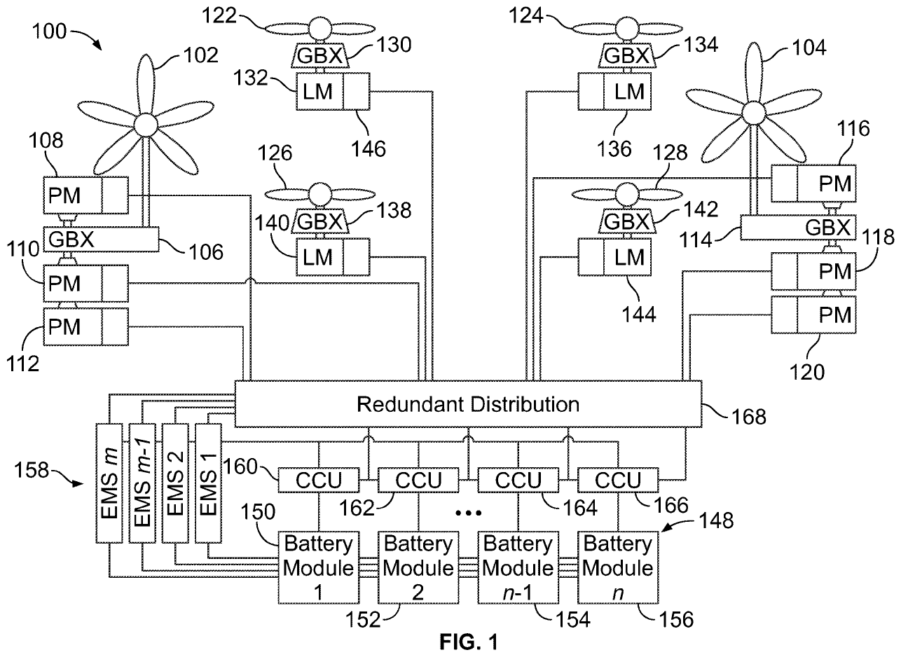

FIG. 1 is a block diagram of a vehicle 100, according to an exemplary embodiment of the present invention. In some embodiments, and as noted above, the vehicle 100 may be a VTOL, which may or may not use electric power to hover, takeoff, and/or land. It should be understood that in other embodiments, the vehicle 100 may be any other type of vehicle that may be able to utilize the advantages of the present invention, such as a ground vehicle (i.e., an automobile), a sea vehicle (such as a boat), or a flying craft (such as an aerial, floating, soaring, hovering, airborne, aeronautical aircraft, airplane, plane, spacecraft, a helicopter, an airship, or an unmanned aerial vehicle, or a drone).

In some embodiments, the vehicle 100 may include one or more propellers or rotors used to drive the vehicle. Each propeller may be configured, for examples, as tiltrotors, lift rotors, or any other type of rotors. In other embodiments, the vehicle 100 may include one or more turbine engines, one or more tires, one or more ski-structures, or the like instead of the one or more propellers used to drive the vehicle.

For example, a first propeller 102 may be driven by a gearbox 106, which in turn is driven by one or more motors such as propeller motor 108, propeller motor 110, and propeller motor 112. Similarly, a second propeller 104 is driven by a gearbox 114, which in turn is driven by one or more motors such as propeller motor 116, propeller motor 118, and propeller motor 120. In some embodiments, the motors may be electric motors.

The vehicle 100 also may include multiple lift rotors, such as multiple lift rotors that can facilitate vertical takeoff and landing of the vehicle 100. For example, the vehicle 100 can include a lift rotor 122, a lift rotor 124, a lift rotor 126, and a lift rotor 128.

The lift rotor 122 is driven by a gearbox 130, which in turn is driven by a motor 132. The lift rotor 124 is driven by a gearbox 134, which in turn is driven by a motor 136. The lift rotor 126 is driven by a gearbox 138, which in turn is driven by a motor 140. The lift rotor 128 is driven by a gearbox 142, which in turn is driven by a motor 144.

In one embodiment, each of the motors described above may include one or more respective motor controllers integrated therewith. For example, the lift motor 132 has one or more motor controllers 146 integrated therewith. Example motor controllers are described below.

In some embodiments, the various motors of the vehicle 100 may be electric motors driven by electric power provided by a plurality of batteries. As depicted in in FIG. 1, the vehicle 100 can have “n” battery modules 148, such as battery module 150, battery module 152, battery module 154, and battery module 156. In an example, the battery modules can be Lithium-ion (Li-Ion) batteries. Each battery module can include a housing or enclosure that houses a plurality of battery cells arranged in rows and columns.

The battery modules 148 are configured to store electric power, and provide electric power to the various electric motors when commanded by respective energy management systems of the vehicle 100. Particularly, in an example implementation, the vehicle 100 can have a plurality (“m”) of energy management systems (EMSs) 158 that are in communication with the battery modules 148. The EMSs 158 are configured as electronic regulators that monitor and control the charging and discharging of the battery modules 148.

In an example, the EMSs 158 are configured to measure voltages of the battery modules 148 and stop charging them when a desired voltage is reached. Further, the EMSs 158 can be configured to monitor parameters that affect life and/or performance of the battery modules 148 as well as ensuring safe operation of the battery modules 148. Safe operation includes, as examples, operating below a threshold temperature to elongate the life of the battery modules 148, preclude overheating, preclude failure of the battery modules, 148, etc.

The EMSs 158 can monitor and control parameters of the battery modules 148. For example, the EMSs 158 monitor and control main power voltage, battery or cell voltage, charging and discharge rates of the battery modules 148, temperatures of the battery modules 148 or their individual cells, health of the battery modules 148 or their individual cells, coolant temperature and flow for air or liquid cooling parameters of a cooling system of the battery modules 148 or their individual cells, etc.

The vehicle 100 may further include multiple contactor control units (CCUs), such as CCU 160, CCU 162, CCU 164, and CCU 166, which are electrically coupled to the battery modules 148, and are in communication with the EMSs 158. In one embodiment, as illustrated in FIG. 1, each CCU is coupled to a respective battery module of the battery modules 148. A contactor is an electrically-controlled switch used for switching an electrical power circuit. A CCU controls the actuation of the contactor to allow power flow to and from the respective battery module. For example, the EMSs 158 control the power flow to and from the battery modules 148 based on power demand from the various electric motors, and accordingly control the CCUs to enable power flow from particular battery modules as desired.

The vehicle 100 may be configured to include a distributed electric propulsion system configured to provide the vehicle 100 with the required energy to power the multiple propellers and lift rotors via an electric transmission system. Particularly, the vehicle 100 can include a redundant distribution module 168 in communication with the EMSs 158, and the redundant distribution module 168 is electrically coupled to the battery modules 148 via the respective CCUs, and is configured to provide electric power, via transmission lines, to the multiple electric motors of the vehicle 100.

The EMSs 158 along with the redundant distribution module 168 can provide for redundancy in the vehicle 100 such that if, for example, one propeller or one lift rotor fails, power can be distributed to other propellers or lift rotors to maintain operation of the vehicle 100.

As described above, due to weight and space constraints in a vehicle such as the vehicle 100, it may be desirable to integrate components in a manner that increases power density and efficiency, while reducing envelope size of the assemblies. Described next is an assembly of an electric motor integrated with a gearbox. The assembly can represent any of the electric motors and gearboxes described above with respect to FIG. 1.

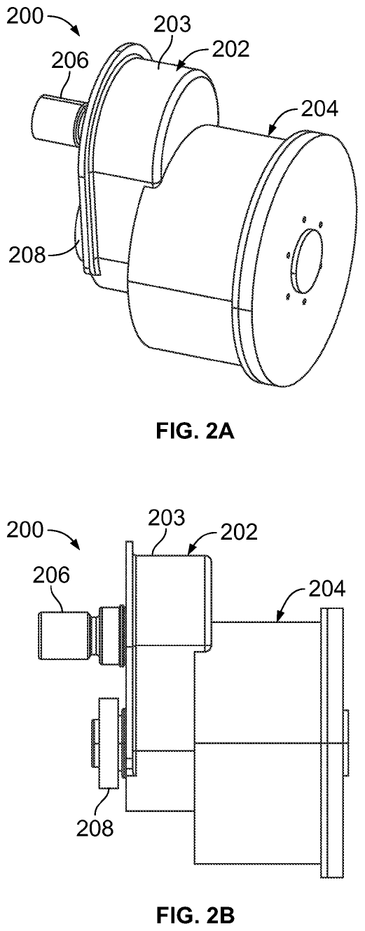

FIG. 2A illustrates a perspective view of an assembly 200 of a gearbox 202 and an electric motor 204, and FIG. 2B illustrates a side view of the assembly 200, according to exemplary embodiments of the present invention. The gearbox 202 can represent any of the gearboxes described above with respect to FIG. 1, and the electric motor 204 can represent any of the electric motors described above with respect to FIG. 1.

For example, the gearbox 202 has a gearbox housing 203 mounted to the electric motor 204. In the illustrated embodiment, the gearbox 202 further has a gearbox output shaft 206 that can be coupled to any of the propellers or lift rotors described above with respect to FIG. 1. The gearbox 202 may be configured to change the speed and torque produced by the electric motor 204 to drive such propeller or lift rotor.

The assembly 200 may further include a bearing 208 mounted outside the gearbox housing 203 to an output shaft (e.g., a spindle 320 described below) of the electric motor 204. The assembly 200 may be mounted to a structure (e.g., any structural part of the vehicle 100), and the bearing 208 may facilitate mounting the assembly 200 to such structure while allowing the output shaft of the electric motor 204 to rotate relative to the structure to drive the gearbox 202.

The gearbox 202 may be single gearbox or a multi-stage gearbox (i.e., a combination of gearboxes that are connected). Further, the gearbox 202 may be of any type (e.g., planetary gear box, a continuous variable transmission, an infinitely variable transmission, etc.).

FIG. 2C illustrates a perspective cross-sectional view of the assembly 200, and FIG. 2D illustrates a cross-sectional side view of the assembly 200, according to exemplary embodiments of the present invention. FIGS. 2C-2D are described together.

The electric motor 204 may include an outer cooling jacket 210, an inner cooling jacket 212, and an end plate 214 mounted to the outer cooling jacket 210. The outer cooling jacket 210 and the inner cooling jacket 212 may be generally cylindrical as illustrated in FIGS. 2C-2D. The outer cooling jacket 210 may operate as a housing for the electric motor 204. The gearbox housing 203 may be mounted to the outer cooling jacket 210 as shown in FIGS. 2C-2D.

In an example embodiment, the electric motor 204 is configured as a dual stator electric motor. Particularly, in an example embodiment, the electric motor 204 includes two separate concentric stators with a rotor radially-interposed between the stators. The stators and rotor of the electric motor 204 may be interposed between the outer cooling jacket 210 and the inner cooling jacket 212.

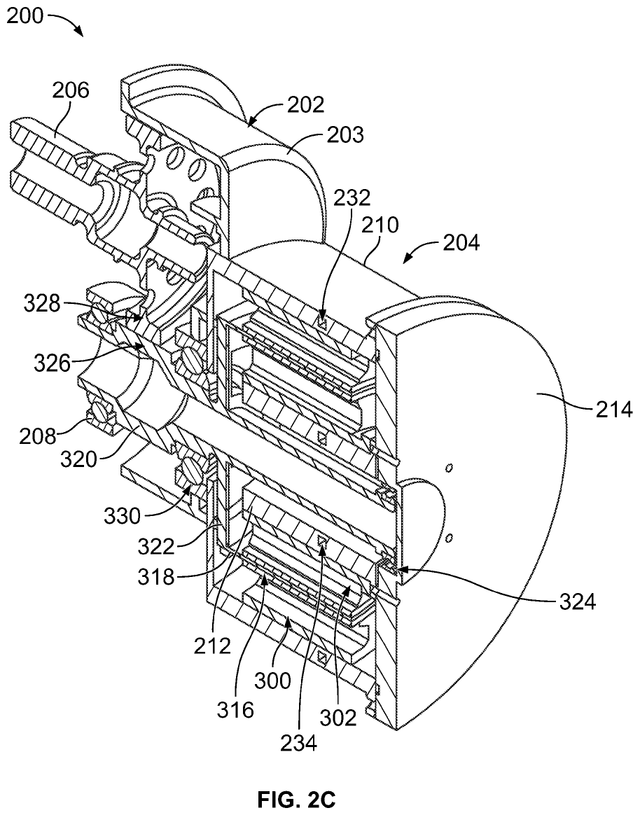

FIG. 3A illustrates a partial perspective view of the electric motor 204, and FIG. 3B illustrates a partial front view of the electric motor 204, according to exemplary embodiments of the present invention. Referring to FIGS. 2C-2D and FIGS. 3A-3B together, the electric motor 204 may include an outer stator 300 and an inner stator 302 that are concentric. The outer stator 300 and the inner stator 302 can have the same or different number of slots and poles.

The outer stator 300 can include one or more stator lamination stacks, each lamination stacking including a plurality of laminations (e.g., thin metal sheets that are stacked together). The outer stator 300 may also include wire windings, such as wire windings 304 shown in FIGS. 3A-3B, wrapped about the stator lamination stack. When electric current is provided through the wire windings of the outer stator 300, a magnetic field is generated.

The outer stator 300 forms an annular space therein, and the inner stator 302 is disposed within such annular space. Similar to the outer stator 300, the inner stator 302 can include one or more stator lamination stacks. The inner stator 302 may also include wire windings, such as wire windings 306 shown in FIGS. 3A-3B, wrapped about the stator lamination stack. When electric current is provided through the wire windings of the inner stator 302, a respective magnetic field is generated.

In an example embodiment, the outer stator 300 is mounted to the outer cooling jacket 210, and the inner stator 302 is mounted to the inner cooling jacket 212. Particularly, an exterior peripheral surface of the outer stator 300 may interface with and may be mounted to an interior peripheral surface of the outer cooling jacket 210. On the other hand, an interior peripheral surface of the inner stator 302 may interface with and may be mounted to an exterior peripheral surface of the inner cooling jacket 212. As such, the outer cooling jacket 210 and the inner cooling jacket 212 may be configured as a frame of the electric motor 204 to which other components (e.g., the outer stator 300 and the inner stator 302) are mounted.

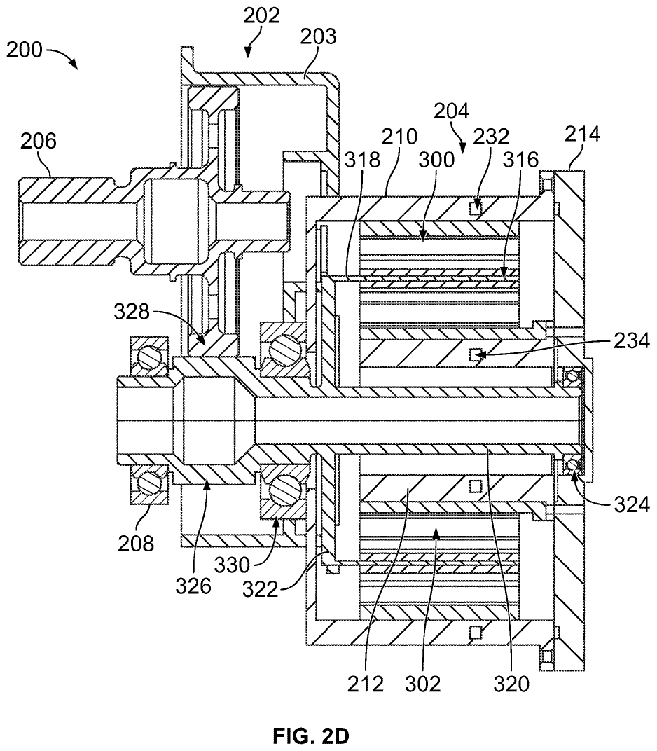

FIG. 4 illustrates a front view of a stator assembly 400 having the outer stator 300 and the inner stator 302, according to exemplary embodiments of the present invention. The stator assembly 400 represents the components of the electric motor 204 that do not rotate. As shown in the illustrated embodiment, the outer stator 300 has a larger diameter than the inner stator 302 and a radial gap 402 exists therebetween.

Referring to FIGS. 2C-2D, 3A-3B, and 4 together, the electric motor 204 may further include a rotor 316 radially-interposed between the outer stator 300 and the inner stator 302, i.e., disposed in the radial gap 402 between the outer stator 300 and the inner stator 302. As shown in FIG. 2C-2D, the rotor 316 may have a cylindrical portion 318 and a spindle 320 coupled to each other via a rotor disk 322. The spindle 320 operates as an output shaft of the electric motor 204. As depicted, the gearbox output shaft 206 is radially offset from the spindle 320.

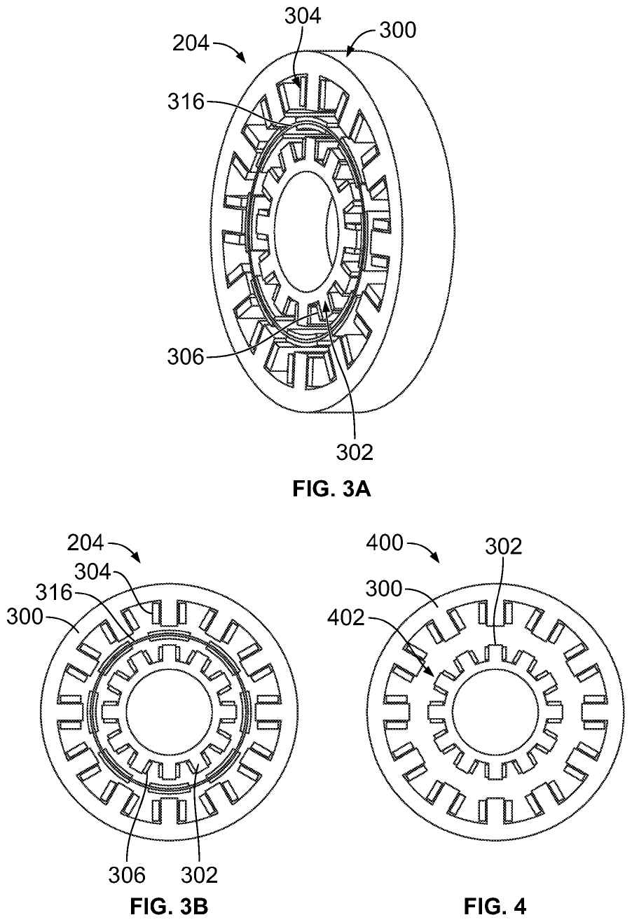

FIG. 5A illustrates a simplified partial side view of a rotor assembly 500 including the rotor 316, and FIG. 5B illustrates a front view of the rotor assembly 500, according to exemplary embodiments of the present invention. The rotor assembly 500 shown in FIGS. 5A-5B represents components of the electric motor 204 that rotate when electric power is provided to the respective windings of the outer stator 300 and the inner stator 302.

The electric motor 204 may include a plurality of magnets that can be considered part of the rotor assembly 500. Particularly, in an example embodiment, the electric motor 204 includes a first set of magnets, such as magnet 502 and magnet 504, which are mounted to, and disposed in a circular or circumferential array about, an exterior surface of the cylindrical portion 318 of the rotor 316. In an example embodiment, the magnets of the first set of magnets are thus disposed in an air gap between the rotor 316 and the outer stator 300.

The electric motor 204 may also include a second set of magnets, such as magnet 506 and magnet 508, which are mounted to, and disposed in a circular or circumferential array about, an interior surface of the cylindrical portion 318 of the rotor 316. In an example embodiment, the magnets of the second set of magnets are thus disposed in an air gap between the rotor 316 and the inner stator 302.

The magnets may be configured to interact with the magnetic field generated by the outer stator 300 and the inner stator 302 to rotate the rotor 316 and produce torque at the spindle 320. Particularly, in an example embodiment, the output torque corresponds to the algebraic sum of two independent torques, one resulting from the current provided to the windings of the outer stator 300 and another resulting from the current provided to the windings of the inner stator 302. By having two independent torque components, the low frequency operation of the electric motor 204 may be enhanced. This configuration also may enhance torque density, as two air-gaps are combined to deliver the output torque, and the torque is produced by the separate currents of both stators.

The number of magnets, stator slots, and windings can be changed to achieve a different power, torque, and speed as desired. Further, the size of the magnets (height, arc, etc.) can be changed to achieve different speeds and powers as desired. Further, although the arrangement of outer stator 300, the inner stator 302, and the magnets are shown as symmetric, in other examples, the electric motor 204 may include an asymmetric arrangement. For example, different air gap sizes could be used (e.g., the air gap between the rotor 316 and the outer stator 300 can be different from the air gap between the rotor 316 and the inner stator 302).

The configuration of the electric motor 204 may allow for redundancy. Particularly, in an example embodiment, if the outer stator 300 or the inner stator 302 fails, the other stator may continue to operate, providing torque to the spindle 320 until the vehicle reaches safe conditions.

Although the electric motor 204 shown and described herein is a dual stator electric motor, in other example embodiments, an electric motor with at least one stator could be used. Such electric motor may include at least one cooling jacket and one set of magnets for the rotor of the electric motor.

Referring back to FIGS. 2C-2D, the spindle 320 may be supported via a bearing 324 mounted within the end plate 214 of the electric motor 204. In an example embodiment, the bearing 324 is mounted about an exterior surface of the spindle 320 of the rotor 316 to allow the rotor 316 to rotate relative to the fixed components of the electric motor 204 (e.g., relative to the outer stator 300, the inner stator 302, and the end plate 214).

The spindle 320 may extend outside the outer cooling jacket 210 to engage with the gearbox 202. Particularly, in an example embodiment, the spindle 320 is disposed through the gearbox 202 and protrudes outward therefrom to facilitate mounting the assembly 200 to a structure via the bearing 208, which is mounted to the spindle 320.

Referring to FIG. 2D, the spindle 320 may have a gear 326 mounted thereto or integrated therewith. The gear 326 may engage a gear 328 within the gearbox 202, which may be coupled to and configured to drive the gearbox output shaft 206, which might in turn be coupled to the propellers or lift rotors of the vehicle 100, for example.

In an example embodiment, while a first end of the spindle 320 is supported by the bearing 324, a second end of the spindle 320 is supported by the bearing 208. Further, in an example embodiment, the spindle 320 is also supported by a bearing 330 disposed, at least partially, within the gearbox 202. Particularly, in an example embodiment, the gearbox housing 203 is mounted to an outer race of the bearing 330, while the inner race of the bearing 330 is mounted to the spindle 320, thus enabling the spindle 320 to rotate relative to the gearbox housing 203.

With this configuration, the electric motor 204 and the gearbox 202 may share components. For example, rather than having an output shaft of the electric motor coupled to another shaft of the gearbox, the spindle 320, which operates as the output shaft of the electric motor 204, extends through and drives the gears (e.g., the gear 328) of the gearbox 202. In an example embodiment, the gearbox housing 203 is mounted to the outer cooling jacket 210 of the electric motor 204 in a compact configuration. Further, in an example embodiment, the electric motor 204 (particularly the spindle 320) shares the bearing 330 with the gearbox 202 rather than having bearings of an electric motor separate from and in addition to respective bearings of a gearbox as in conventional configurations.

During operation of the assembly 200, heat may be generated by the electric motor 204 and the heat is distributed throughout multiple components within the electric motor 204. For example, heat is generated due to losses within the wire windings and the laminations of the outer stator 300 and the inner stator 302 and within the rotor laminations and magnets of the rotor 316. The distribution of the generated heat within the components may be dependent on the type of the electric motor 204 and the operating condition (e.g., torque, speed) of the electric motor 204. The heat generated within the electric motor 204 may raise the internal temperature of the electric motor 204, making the wire windings of the electric motor 204 more susceptible to burn out. It may thus be desirable to cool the electric motor 204 to preclude the temperature from exceeding a threshold safe temperature.

In an example embodiment, the gearbox 202 is configured to have a “wet” design, i.e., the gearbox 202 can filled with fluid (e.g., oil) to reduce friction between the gears and cool the gearbox 202. In the assemblies disclosed herein, such fluid may be provided from the gearbox 202 through the electric motor 204 to facilitate cooling the electric motor 204.

Particularly, referring to FIGS. 2C-2D, fluid may be provided from the gearbox 202 through the outer cooling jacket 210 and the inner cooling jacket 212 of the electric motor 204. In an example embodiment, fluid is provided internally through channels in the gearbox housing 203 to respective channels in the outer cooling jacket 210 and the inner cooling jacket 212. In another example embodiment, the fluid may be provided externally from the gearbox 202 (e.g., through external fluid lines) then provided to ports in the outer cooling jackets 210. Fluid can then flow from channels in the outer cooling jacket 210 to the inner cooling jacket 212.

The outer cooling jacket 210 may have channels such as channel 232 that traverses through the outer cooling jacket 210 to circulate the fluid from the gearbox 202 therethrough. Similarly, the inner cooling jacket 212 may have channels such as channel 234 that traverses through the inner cooling jacket 212 to circulate the fluid from the gearbox 202 therethrough. As fluid circulates through the outer cooling jacket 210 and the inner cooling jacket 212, it may absorb heat generated within the electric motor 204, thereby reducing the temperature of the electric motor.

In one example embodiment, the assembly 200 may include a pump (now shown), which can be used to draw the fluid of the gearbox 202, pump the fluid through the channel 232 of the outer cooling jacket 210 and the channel 234 of the inner cooling jacket 212 to cool the electric motor 204, and then fluid is returned to the gearbox 202. In an example embodiment, the pump is an active pump. In other words, the pump can be a gear pump, a vane pump, a piston pump, etc. In another example embodiment, the pump is a passive pump that relies on surface tension induced pressure differences to drive fluid movement in closed channels connecting the gearbox 202 to the electric motor 204. Valves with micro-nozzles can be used to facilitate passive pumping of fluid from the gearbox 202 to the electric motor 204, for example.

In these examples, fluid is being cooled via the combined surface areas of the gearbox housing 203 as well as the outer cooling jacket 210 and the inner cooling jacket 212. This way, the effective cooling area of the electric motor 204 is increased to include the surface area of the gearbox housing 203, thereby increasing the cooling capacity of the assembly 200. This configuration may allow for the use of smaller, more power dense components, improves life and efficiency of the electrical components, and may allow the electrical components to operate at a high power rating.

In an example embodiment, the vehicle 100 or any system including the assembly 200 may further include a heat exchanger. Fluid of the gearbox 202 may be provided to a heat exchanger (e.g., a radiator) to reduce its temperature before returning it back to the gearbox 202 or the electric motor 204. In this manner, cooling efficiency of the fluid may be enhanced.

Although the electric motor 204 is shown and described as a permanent magnet motor, other types of electric motors could be used in the assembly 200. For example, a switch reluctance motor or a flux switching motor could be used.

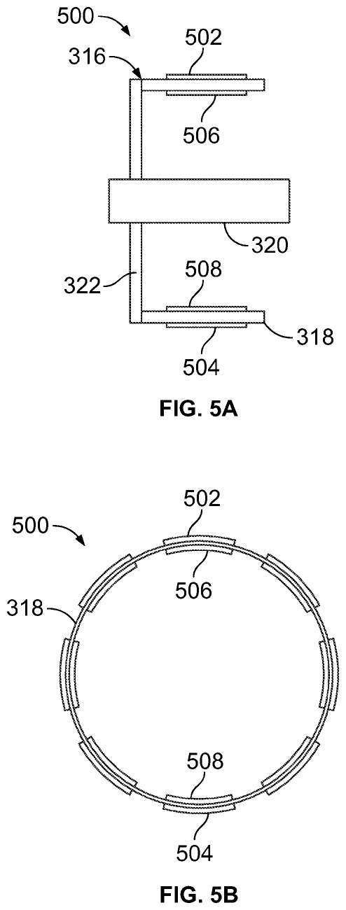

FIG. 6 illustrates a front view of an electric motor 600 configured as a reluctance motor according to exemplary embodiments of the present invention. As a reluctance motor, the electric motor 600 is a type of electric motor that induces non-permanent magnetic poles on a ferromagnetic rotor. The rotor does not have any wire windings, but rather generates torque through magnetic reluctance. The electric motor 600 can be a synchronous, variable, or switched reluctance motor.

Similar to the electric motor 204, the electric motor 600 may include an outer stator 602 and an inner stator 604 that are concentric. The outer stator 602 has a number of teeth or poles such as pole 603, and the inner stator 604 can have a respective number of teeth or poles such as pole 605. The outer stator 602 and the inner stator 604 can have the same or different number of slots and poles.

The outer stator 602 may include wire windings, such as wire windings 606, wrapped about the poles of the outer stator lamination stack. When electric current is provided through the wire windings of the outer stator 602, a magnetic field is generated.

The outer stator 602 forms an annular space therein, and the inner stator 604 is disposed within such annular space. Similar to the outer stator 602, the inner stator 604 may include wire windings, such as wire windings 608, wrapped about the poles of the inner stator lamination stack. When electric current is provided through the wire windings of the inner stator 604, a respective magnetic field is generated.

In an example embodiment, the outer stator 602 is mounted to the outer cooling jacket 210, and the inner stator 604 is mounted to the inner cooling jacket 212. Particularly, an exterior peripheral surface of the outer stator 602 may interface with and may be mounted to an interior peripheral surface of the outer cooling jacket 210. On the other hand, an interior peripheral surface of the inner stator 604 may interface with and may be mounted to an exterior peripheral surface of the inner cooling jacket 212. As such, the outer cooling jacket 210 and the inner cooling jacket 212 may be configured as a frame of the electric motor 600 to which other components (e.g., the outer stator 602 and the inner stator 604) are mounted.

The poles of the outer stator 602 and the inner stator 604 can be referred to as “salient-poles,” where “saliency” indicates “projecting beyond the general outline” of the respective stator (e.g., the poles project or “stand out” from the otherwise-smooth circle of the respective stator surface).

As depicted in FIG. 6, the electric motor 600 may further include a rotor 610 radially-interposed between the outer stator 602 and the inner stator 604. The rotor 610 may have a cylindrical portion 612. The rotor 610 may also have a spindle (not shown) coupled to the cylindrical portion 612 via a rotor disk (not shown) similar to the rotor 316. In an example, the rotor 610, the outer stator 602, and the inner stator 604 may be made of a ferromagnetic material (materials with a large magnetic permeability).

The rotor 610 may include a plurality of salient poles such as salient pole 614. Each of the salient poles projects from both sides of the cylindrical portion 612 of the rotor 610. For example, a portion of the salient pole 614 projects outward toward the outer stator 602, and another portion of the salient pole 614 projects inward toward the inner stator 604.

With the configuration of the electric motor 600, the outer stator 602 has multiple inward-projecting (salient) electromagnet poles (poles with wire windings wrapped thereabout to generate a magnetic field when an electric current is provided thereto). Similarly, the inner stator 604 has multiple outward-projecting (salient) electromagnet poles (poles with wire windings wrapped thereabout to generate a magnetic field when an electric current is provided thereto). Further, the rotor 610 can be made of soft magnetic material, such as laminated silicon steel, which has multiple saliencies (projections) such as salient pole 614. The salient poles of the rotor 610 act as salient magnetic poles through magnetic reluctance when interacting with the magnetic field generated by the outer stator 602 and the inner stator 604.

In an example embodiment, if the electric motor 600 is a switched reluctance motor, the number of rotor salient poles can be less than the number of stator poles. This configuration may reduce torque ripple and prevent the poles from all aligning simultaneously, which is a position at which no torque is generated.

In another example embodiment, if the electric motor 600 is a synchronous reluctance motors, it may have an equal number of stator and rotor poles. The rotor 610 may operate at synchronous speeds without current-conducting parts. When a stator pole is equidistant from two adjacent rotor poles, the stator pole is considered in the “fully unaligned position.” This is the position of maximum magnetic reluctance for the rotor pole. In the “aligned position,” two (or more) rotor poles are fully aligned with two (or more) stator poles, (which means the rotor poles completely face the stator poles) and is a position of minimum reluctance.

When a stator pole is energized (e.g., when the wire windings 606 of the pole 603 is energized), the rotor torque is in the direction that reduces reluctance. Thus, the nearest rotor pole is pulled from the unaligned position into alignment with the stator field (a position of less reluctance). To sustain rotation, the stator field rotates in advance of the rotor poles, thus constantly “pulling” the rotor along.

The number of rotor saliencies, stator poles, and windings can be changed to achieve a different power, torque, and speed as desired. Further, the size of the saliencies (height, arc, etc.) can be changed to achieve different speeds and powers as desired. Further, although the arrangement of outer stator 602, the inner stator 604, and the rotor saliencies are shown as symmetric, in other examples, the electric motor 600 may include an asymmetric arrangement. For example, different air gap sizes could be used (e.g., the air gap between the rotor 610 and the outer stator 602 can be different from the air gap between the rotor 610 and the inner stator 604).

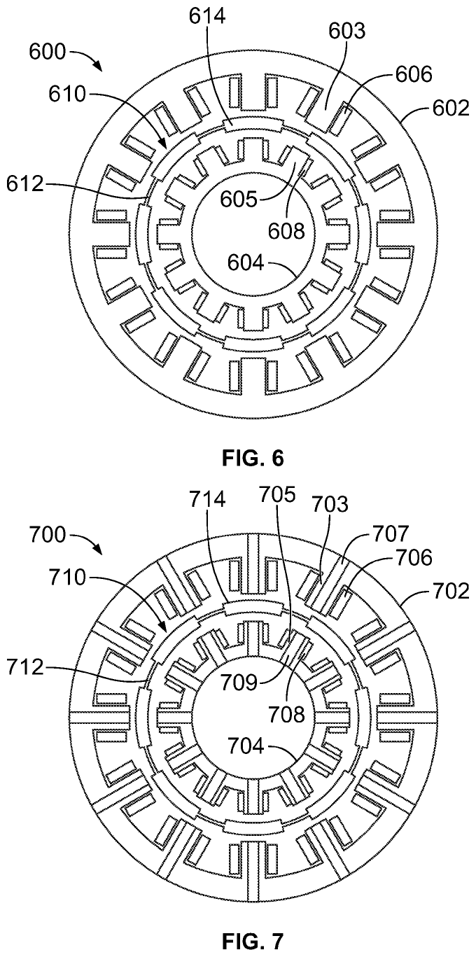

FIG. 7 illustrates a front view of an electric motor 700 configured as a flux switching motor according to exemplary embodiments of the present invention. As a flux switching motor, the electric motor 600 is a type of electric motor where permanent magnets and wire windings are mounted to the stator, while the rotor has saliencies but no wire windings or magnets.

The electric motor 700 may include an outer stator 702 and an inner stator 704 that are concentric. The outer stator 702 has a number of teeth or poles such as pole 703, and the inner stator 704 can have a respective number of teeth or poles such as pole 705. The outer stator 702 and the inner stator 704 can have the same or different number of slots and poles.

The outer stator 702 may include wire windings, such as wire windings 706, wrapped about the poles of the outer stator lamination stack. When electric current is provided through the wire windings of the outer stator 702, a magnetic field is generated.

The outer stator 702 forms an annular space therein, and the inner stator 704 is disposed within such annular space. Similar to the outer stator 702, the inner stator 704 may include wire windings, such as wire windings 708, wrapped about the poles of the inner stator lamination stack. When electric current is provided through the wire windings of the inner stator 704, a respective magnetic field is generated.

Further, the outer stator 702 and the inner stator 704 have permanent magnets disposed therein aligned with their respective poles. The magnets are disposed in circular arrays about the respective stator. For example, the outer stator 702 has a magnet 707 disposed partially in the pole 703, and the inner stator 704 has a magnet 709 disposed partially in the pole 705.

In an example embodiment, the outer stator 702 is mounted to the outer cooling jacket 210, and the inner stator 704 is mounted to the inner cooling jacket 212. Particularly, an exterior peripheral surface of the outer stator 702 may interface with and may be mounted to an interior peripheral surface of the outer cooling jacket 210. On the other hand, an interior peripheral surface of the inner stator 704 may interface with and may be mounted to an exterior peripheral surface of the inner cooling jacket 212. As such, the outer cooling jacket 210 and the inner cooling jacket 212 may be configured as a frame of the electric motor 700 to which other components (e.g., the outer stator 702 and the inner stator 704) are mounted.

The poles of the outer stator 702 and the inner stator 704 can be referred to as “salient-poles,” where “saliency” indicates “projecting beyond the general outline” of the respective stator (e.g., the poles project or “stand out” from the otherwise-smooth circle of the respective stator surface).

As depicted in FIG. 7, the electric motor 700 may further include a rotor 710 radially-interposed between the outer stator 702 and the inner stator 704. The rotor 710 is similar to the rotor 610 and may have a cylindrical portion 712. The rotor 710 may also have a spindle (not shown) coupled to the cylindrical portion 712 via a rotor disk (not shown) similar to the rotor 316. In an example, the rotor 710, the outer stator 702, and the inner stator 704 may be made of a ferromagnetic material.

The rotor 710 may include a plurality of salient poles such as salient pole 714. Each of the salient poles projects from both sides of the cylindrical portion 712 of the rotor 710. For example, a portion of the salient pole 714 projects outward toward the outer stator 702, and another portion of the salient pole 714 projects inward toward the inner stator 704.

The number of rotor saliencies, stator poles, and windings can be changed to achieve a different power, torque, and speed as desired. Further, the size of the saliencies (height, arc, etc.) can be changed to achieve different speeds and powers as desired. Further, although the arrangement of outer stator 702, the inner stator 704, and the rotor saliencies are shown as symmetric, in other examples, the electric motor 700 may include an asymmetric arrangement. For example, different air gap sizes could be used (e.g., the air gap between the rotor 710 and the outer stator 702 can be different from the air gap between the rotor 710 and the inner stator 704).

In the embodiments of FIGS. 2A-2D, either the electric motor 600 or the electric motor 700 can replace the electric motor 204.

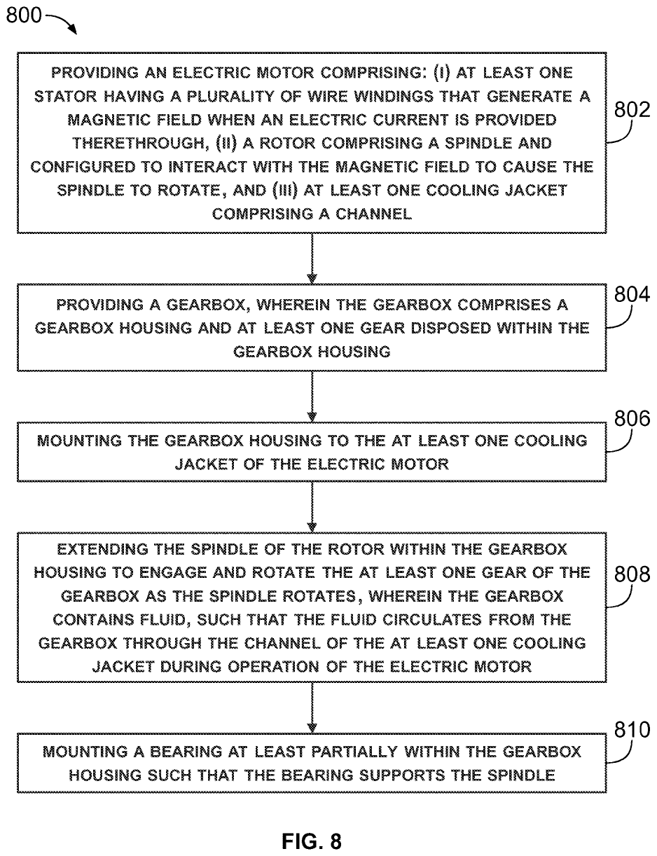

FIG. 8 is a flowchart of a method 800 for assembling the gearbox 202 to the electric motor 204, 600, 700 according to exemplary embodiments of the present invention. As such, the method 800 is for forming the assembly 200. The method 800 may include one or more operations, functions, or actions as illustrated by one or more of steps 802-810.

Although the steps are illustrated in a sequential order, these steps may also be performed in parallel, and/or in a different order than those described herein. Also, the various steps may be combined into fewer steps, divided into additional steps, and/or removed based upon the desired implementation. It should be understood that for this and other processes and methods disclosed herein, flowcharts show functionality and operation of one possible implementation of present examples. Alternative implementations are included within the scope of the examples of the present disclosure in which functions may be executed out of order from that shown or discussed, including substantially concurrent or in reverse order, depending on the functionality involved, as would be understood by those reasonably skilled in the art.

At a step 802, the method 800 includes providing the electric motor 204, 600, 700, which has: (i) at least one stator (e.g., the outer stator 300, 602, 702 and/or the inner stator 302, 604, 704) having a plurality of wire windings (e.g., the wire windings 304, 306, 606, 608, 706, 708) that generate a magnetic field when an electric current is provided therethrough, (ii) the rotor 316, 610, 710 comprising the spindle 320 and configured to interact (e.g., via a plurality of magnets such as the magnets 502, 504 and/or the magnets 506, 508, or via saliences such as the salient pole 614, 714) with the magnetic field to cause the spindle 320 to rotate, and (iii) at least one cooling jacket (e.g., the outer cooling jacket 210 and/or the inner cooling jacket 212) comprising a channel (e.g., the channel 232 and/or the channel 234).

The term “providing” as used herein, and for example with regard to the electric motor 204, 600, 700, the gearbox 202, or other components, includes any action to make the electric motor 204, 600, 700, or any other component available for use, such as bringing the electric motor 204, 600, 700, or components thereof to an apparatus or to a work environment for further processing (e.g., mounting other components, etc.).

At a step 804, the method 800 includes providing the gearbox 202, wherein the gearbox 202 comprises the gearbox housing 203 and at least one gear (e.g., the gear 328) disposed within the gearbox housing 203.

At a step 806, the method 800 includes mounting the gearbox housing 203 to the at least one cooling jacket of the electric motor 204, 600, 700.

At a step 808, the method 800 includes extending the spindle 320 of the rotor 316, 610, 710 within the gearbox housing 203 to engage and rotate the at least one gear of the gearbox 202 as the spindle 320 rotates, wherein the gearbox 202 contains fluid, such that the fluid circulates from the gearbox 202 through the channel of the at least one cooling jacket during operation of the electric motor 204.

At a step 810, the method 800 includes mounting the bearing 330 at least partially within the gearbox housing 203 such that the bearing 330 supports the spindle 320.

The method 800 can include other steps as well. For instance, the at least one cooling jacket comprises: (i) the outer cooling jacket 210 comprising the channel 232, and (ii) the inner cooling jacket 212 comprising the channel 234, wherein the fluid of the gearbox 202 circulates from the gearbox 202 through the channel 232 of the outer cooling jacket 210 and through the channel 234 of the inner cooling jacket 212, and mounting the gearbox housing 203 to the at least one cooling jacket comprises: mounting the gearbox housing 203 to the outer cooling jacket 210.

As another example, the electric motor 204, 600, 700 further comprises the end plate 214 mounted to the at least one cooling jacket, and the method further comprises: mounting the bearing 324 to the spindle 320 and within the end plate 214 to support the spindle 320.

As another example, extending the spindle 320 within the gearbox housing 203 can include extending the spindle 320 through the gearbox housing 203 such that the spindle 320 protrudes outward from the gearbox housing 203, and wherein the method further includes: mounting the bearing 208 to the spindle 320 outside the gearbox housing 203 to facilitate mounting the gearbox 202 and the electric motor 204, 600, 700 to a structure while allowing the spindle 320 to rotate relative to the structure.

The method 800 can further include other steps as described throughout herein.

The detailed description above describes various features and operations of the disclosed systems with reference to the accompanying figures. The illustrative implementations described herein are not meant to be limiting. Certain aspects of the disclosed systems can be arranged and combined in a wide variety of different configurations, all of which are contemplated herein.

Further, unless context suggests otherwise, the features illustrated in each of the figures may be used in combination with one another. Thus, the figures should be generally viewed as component aspects of one or more overall implementations, with the understanding that not all illustrated features are necessary for each implementation.

Additionally, any enumeration of elements, steps, or blocks in this specification or the claims is for purposes of clarity. Thus, such enumeration should not be interpreted to require or imply that these elements, steps, or blocks adhere to a particular arrangement or are carried out in a particular order.

Further, devices or systems may be used or configured to perform functions presented in the figures. In some instances, components of the devices and/or systems may be configured to perform the functions such that the components are actually configured and structured (with hardware and/or software) to enable such performance. In other examples, components of the devices and/or systems may be arranged to be adapted to, capable of, or suited for performing the functions, such as when operated in a specific manner.

By the term “substantially” or “about” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

The arrangements described herein are for purposes of example only. As such, those skilled in the art will appreciate that other arrangements and other elements (e.g., machines, interfaces, operations, orders, and groupings of operations, etc.) can be used instead, and some elements may be omitted altogether according to the desired results. Further, many of the elements that are described are functional entities that may be implemented as discrete or distributed components or in conjunction with other components, in any suitable combination and location.

While various aspects and implementations have been disclosed herein, other aspects and implementations will be apparent to those skilled in the art. The various aspects and implementations disclosed herein are for purposes of illustration and are not intended to be limiting, with the true scope being indicated by the following claims, along with the full scope of equivalents to which such claims are entitled. Also, the terminology used herein is for the purpose of describing particular implementations only, and is not intended to be limiting.

Implementations of the present disclosure can thus relate to one of the enumerated example embodiments (EEEs) listed below.
EEE 1 is an assembly comprising: an electric motor comprising: (i) at least one stator having a plurality of wire windings that generate a magnetic field when an electric current is provided therethrough, (ii) a rotor comprising a spindle and configured to interact with the magnetic field to cause the spindle to rotate, and (iii) at least one cooling jacket comprising a channel; a gearbox comprising (i) a gearbox housing mounted to the at least one cooling jacket of the electric motor, and (ii) at least one gear disposed within the gearbox housing, wherein the spindle of the rotor extends within the gearbox housing to engage and rotate the at least one gear of the gearbox as the spindle rotates, wherein the gearbox contains fluid, such that the fluid circulates from the gearbox through the channel of the at least one cooling jacket; and a bearing disposed at least partially within the gearbox housing and configured to support the spindle.
EEE 2 is the assembly of EEE 1, wherein the at least one stator comprises: an outer stator; and an inner stator disposed within the outer stator such that a radial gap is formed between the outer stator and the inner stator, wherein the rotor is positioned in the radial gap, radially interposed between the outer stator and the inner stator.
EEE 3 is the assembly of EEE 2, wherein the at least one cooling jacket comprises: an outer cooling jacket to which the outer stator and the gearbox housing are mounted, wherein the outer cooling jacket comprises the channel; and an inner cooling jacket to which the inner stator is mounted, wherein the inner cooling jacket comprises a respective channel, wherein the fluid of the gearbox circulates from the gearbox through the channel of the outer cooling jacket and through the respective channel of the inner cooling jacket during operation of the assembly.
EEE 4 is the assembly of any of EEEs 2-3, wherein the rotor comprises: a cylindrical portion that is radially-interposed between the outer stator and the inner stator; and a rotor disk coupled to the cylindrical portion, wherein the spindle is coupled to the rotor disk.
EEE 5 is the assembly of EEE 4, wherein the rotor further comprises: a first set of magnets mounted to, and disposed in a circumferential array about, an exterior surface of the cylindrical portion between the cylindrical portion and the outer stator; and a second set of magnets mounted to, and disposed in a circumferential array about, an interior surface of the cylindrical portion between the cylindrical portion and the inner stator.
EEE 6 is the assembly of EEE 4, wherein the rotor further comprises: a plurality of salient poles formed in a circular array about the cylindrical portion of the rotor, wherein each salient pole of the plurality of salient poles protrudes radially-outward toward the outer stator and protrudes radially-inward toward the inner stator.
EEE 7 is the assembly of EEE 6, wherein the outer stator further comprises a plurality of permanent magnets disposed in a circular array about the outer stator, and wherein the outer stator further comprises a respective plurality of permanent magnets disposed in a circular array about the inner stator.
EEE 8 is the assembly of any of EEEs 1-7, wherein the bearing is a first bearing, wherein the electric motor further comprises: an end plate mounted to the at least one cooling jacket; and a second bearing mounted to the spindle and within the end plate to support the spindle.
EEE 9 is the assembly of any of EEEs 1-8, wherein the bearing is a first bearing, wherein the spindle extends through the gearbox housing and protrudes outward therefrom, and wherein the assembly further comprises: a second bearing mounted to the spindle outside the gearbox housing, wherein the second bearing facilitates mounting the assembly to a structure while allowing the spindle to rotate relative to the structure.
EEE 10 is the assembly of any of EEEs 1-9, wherein the gearbox comprises a gearbox output shaft, wherein the spindle is radially offset from the gearbox output shaft.
EEE 11 is a vehicle comprising: a propeller; an electric motor comprising: (i) at least one stator having a plurality of wire windings that generate a magnetic field when an electric current is provided therethrough, (ii) a rotor comprising a spindle and configured to interact with the magnetic field to cause the spindle to rotate, and (iii) at least one cooling jacket comprising a channel; a gearbox comprising (i) a gearbox housing mounted to the at least one cooling jacket of the electric motor, (ii) at least one gear disposed within the gearbox housing, wherein the spindle of the rotor extends within the gearbox housing to engage and rotate the at least one gear of the gearbox as the spindle rotates, and (iii) a gearbox output shaft coupled to the propeller, wherein the gearbox output shaft rotates as the spindle of the electric motor and the at least one gear of the gearbox rotate, wherein the gearbox contains fluid, such that the fluid circulates from the gearbox through the channel of the at least one cooling jacket; and a bearing disposed at least partially within the gearbox housing and configured to support the spindle.
EEE 12 is the vehicle of EEE 11, wherein the at least one stator comprises: an outer stator; and an inner stator disposed within the outer stator such that a radial gap is formed between the outer stator and the inner stator, wherein the rotor is positioned in the radial gap, radially interposed between the outer stator and the inner stator.
EEE 13 is the vehicle of EEE 12, wherein the at least one cooling jacket comprises: an outer cooling jacket to which the outer stator and the gearbox housing are mounted, wherein the outer cooling jacket comprises the channel; and an inner cooling jacket to which the inner stator is mounted, wherein the inner cooling jacket comprises a respective channel, wherein the fluid of the gearbox circulates from the gearbox through the channel of the outer cooling jacket and through the respective channel of the inner cooling jacket.
EEE 14 is the vehicle of any of EEEs 12-13, wherein the rotor comprises: a cylindrical portion that is radially-interposed between the outer stator and the inner stator; and a rotor disk coupled to the cylindrical portion, wherein the spindle is coupled to the rotor disk.
EEE 15 is the vehicle of EEE 14, wherein the rotor further comprises: (i) a first set of magnets mounted to, and disposed in a circumferential array about, an exterior surface of the cylindrical portion between the cylindrical portion and the outer stator; and a second set of magnets mounted to, and disposed in a circumferential array about, an interior surface of the cylindrical portion between the cylindrical portion and the inner stator, or (ii) a plurality of salient poles formed in a circular array about the cylindrical portion of the rotor, wherein each salient pole of the plurality of salient poles protrudes radially-outward toward the outer stator and protrudes radially-inward toward the inner stator.
EEE 16 is the vehicle of any of EEEs 11-15, wherein the bearing is a first bearing, wherein the electric motor further comprises: an end plate mounted to the at least one cooling jacket; and a second bearing mounted to the spindle and within the end plate to support the spindle.
EEE 17 is the vehicle of any of EEEs 11-16, wherein the bearing is a first bearing, wherein the spindle extends through the gearbox housing and protrudes outward therefrom, and wherein the vehicle further comprises: a second bearing mounted to the spindle outside the gearbox housing, wherein the second bearing facilitates mounting the gearbox and the electric motor to a structure of the vehicle while allowing the spindle to rotate relative to the structure.
EEE 18 is the vehicle of any of EEEs 11-16, wherein the spindle is radially offset from the gearbox output shaft.
EEE 19 is a method comprising: providing an electric motor comprising: (i) at least one stator having a plurality of wire windings that generate a magnetic field when an electric current is provided therethrough, (ii) a rotor comprising a spindle and configured to interact with the magnetic field to cause the spindle to rotate, and (iii) at least one cooling jacket comprising a channel; providing a gearbox, wherein the gearbox comprises a gearbox housing and at least one gear disposed within the gearbox housing; mounting the gearbox housing to the at least one cooling jacket of the electric motor; extending the spindle of the rotor within the gearbox housing to engage and rotate the at least one gear of the gearbox as the spindle rotates, wherein the gearbox contains fluid, such that the fluid circulates from the gearbox through the channel of the at least one cooling jacket during operation of the electric motor; and mounting a bearing at least partially within the gearbox housing such that the bearing supports the spindle.
EEE 20 is the method of EEE 19, wherein the at least one cooling jacket comprises: (i) an outer cooling jacket comprising the channel, and (ii) an inner cooling jacket comprising a respective channel, wherein the fluid of the gearbox circulates from the gearbox through the channel of the outer cooling jacket and through the respective channel of the inner cooling jacket, wherein mounting the gearbox housing to the at least one cooling jacket comprises: mounting the gearbox housing to the outer cooling jacket.
EEE 21 is the method of any of EEEs 19-20, wherein the bearing is a first bearing, wherein the electric motor further comprises an end plate mounted to the at least one cooling jacket, and wherein the method further comprises: mounting a second bearing to the spindle and within the end plate to support the spindle.
EEE 22 is the method of any of EEEs 19-21, wherein the bearing is a first bearing, wherein extending the spindle within the gearbox housing comprises extending the spindle through the gearbox housing such that the spindle protrudes outward from the gearbox housing, and wherein the method further comprises: mounting a second bearing to the spindle outside the gearbox housing to facilitate mounting the gearbox and the electric motor to a structure while allowing the spindle to rotate relative to the structure.

What is claimed is:

1. An assembly comprising:
an electric motor comprising: (i) at least one stator having a plurality of wire windings that generate a magnetic field when an electric current is provided therethrough, (ii) a rotor comprising a spindle and configured to interact with the magnetic field to cause the spindle to rotate, and (iii) at least one cooling jacket comprising a channel;
a gearbox comprising (i) a gearbox housing mounted to the at least one cooling jacket of the electric motor, and (ii) at least one gear disposed within the gearbox housing, wherein the spindle of the rotor extends within the gearbox housing to engage and rotate the at least one gear of the gearbox as the spindle rotates, wherein the gearbox contains fluid, such that the fluid circulates from the gearbox through the channel of the at least one cooling jacket; and
a bearing disposed at least partially within the gearbox housing and configured to support the spindle.

2. The assembly of claim 1, wherein the at least one stator comprises:
an outer stator; and
an inner stator disposed within the outer stator such that a radial gap is formed between the outer stator and the inner stator, wherein the rotor is positioned in the radial gap, radially interposed between the outer stator and the inner stator.

3. The assembly of claim 2, wherein the at least one cooling jacket comprises:
an outer cooling jacket to which the outer stator and the gearbox housing are mounted, wherein the outer cooling jacket comprises the channel; and
an inner cooling jacket to which the inner stator is mounted, wherein the inner cooling jacket comprises a respective channel, wherein the fluid of the gearbox circulates from the gearbox through the channel of the outer cooling jacket and through the respective channel of the inner cooling jacket during operation of the assembly.

4. The assembly of claim 2, wherein the rotor comprises:
a cylindrical portion that is radially-interposed between the outer stator and the inner stator; and
a rotor disk coupled to the cylindrical portion, wherein the spindle is coupled to the rotor disk.

5. The assembly of claim 4, wherein the rotor further comprises:
a first set of magnets mounted to, and disposed in a circumferential array about, an exterior surface of the cylindrical portion between the cylindrical portion and the outer stator; and
a second set of magnets mounted to, and disposed in a circumferential array about, an interior surface of the cylindrical portion between the cylindrical portion and the inner stator.

6. The assembly of claim 4, wherein the rotor further comprises:
a plurality of salient poles formed in a circular array about the cylindrical portion of the rotor, wherein each salient pole of the plurality of salient poles protrudes radially-outward toward the outer stator and protrudes radially-inward toward the inner stator.

7. The assembly of claim 6, wherein the outer stator further comprises a plurality of permanent magnets disposed in a circular array about the outer stator, and wherein the outer stator further comprises a respective plurality of permanent magnets disposed in a circular array about the inner stator.

8. The assembly of claim 1, wherein the bearing is a first bearing, wherein the electric motor further comprises:
an end plate mounted to the at least one cooling jacket; and
a second bearing mounted to the spindle and within the end plate to support the spindle.

9. The assembly of claim 1, wherein the bearing is a first bearing, wherein the spindle extends through the gearbox housing and protrudes outward therefrom, and wherein the assembly further comprises:
a second bearing mounted to the spindle outside the gearbox housing, wherein the second bearing facilitates mounting the assembly to a structure while allowing the spindle to rotate relative to the structure.

10. The assembly of claim 1, wherein the gearbox comprises a gearbox output shaft, wherein the spindle is radially offset from the gearbox output shaft.

11. A vehicle comprising:
a propeller;
an electric motor comprising: (i) at least one stator having a plurality of wire windings that generate a magnetic field when an electric current is provided therethrough, (ii) a rotor comprising a spindle and configured to interact with the magnetic field to cause the spindle to rotate, and (iii) at least one cooling jacket comprising a channel;
a gearbox comprising (i) a gearbox housing mounted to the at least one cooling jacket of the electric motor, (ii) at least one gear disposed within the gearbox housing, wherein the spindle of the rotor extends within the gearbox housing to engage and rotate the at least one gear of the gearbox as the spindle rotates, and (iii) a gearbox output shaft coupled to the propeller, wherein the gearbox output shaft rotates as the spindle of the electric motor and the at least one gear of the gearbox rotate, wherein the gearbox contains fluid, such that the fluid circulates from the gearbox through the channel of the at least one cooling jacket; and
a bearing disposed at least partially within the gearbox housing and configured to support the spindle.

12. The vehicle of claim 11, wherein the at least one stator comprises:
an outer stator; and
an inner stator disposed within the outer stator such that a radial gap is formed between the outer stator and the inner stator, wherein the rotor is positioned in the radial gap, radially interposed between the outer stator and the inner stator.

13. The vehicle of claim 12, wherein the at least one cooling jacket comprises:
an outer cooling jacket to which the outer stator and the gearbox housing are mounted, wherein the outer cooling jacket comprises the channel; and
an inner cooling jacket to which the inner stator is mounted, wherein the inner cooling jacket comprises a respective channel, wherein the fluid of the gearbox circulates from the gearbox through the channel of the outer cooling jacket and through the respective channel of the inner cooling jacket.

14. The vehicle of claim 12, wherein the rotor comprises:
a cylindrical portion that is radially-interposed between the outer stator and the inner stator; and
a rotor disk coupled to the cylindrical portion, wherein the spindle is coupled to the rotor disk.

15. The vehicle of claim 14, wherein the rotor further comprises: (i) a first set of magnets mounted to, and disposed in a circumferential array about, an exterior surface of the cylindrical portion between the cylindrical portion and the outer stator, and a second set of magnets mounted to, and disposed in a circumferential array about, an interior surface of the cylindrical portion between the cylindrical portion and the inner stator, or (ii) a plurality of salient poles formed in a circular array about the cylindrical portion of the rotor, wherein each salient pole of the plurality of salient poles protrudes radially-outward toward the outer stator and protrudes radially-inward toward the inner stator.

16. The vehicle of claim 11, wherein the bearing is a first bearing, wherein the electric motor further comprises:
an end plate mounted to the at least one cooling jacket; and
a second bearing mounted to the spindle and within the end plate to support the spindle.

17. The vehicle of claim 11, wherein the bearing is a first bearing, wherein the spindle extends through the gearbox housing and protrudes outward therefrom, and wherein the vehicle further comprises:
a second bearing mounted to the spindle outside the gearbox housing, wherein the second bearing facilitates mounting the gearbox and the electric motor to a structure of the vehicle while allowing the spindle to rotate relative to the structure.

18. The vehicle of claim 11, wherein the spindle is radially offset from the gearbox output shaft.

19. A method comprising:
providing an electric motor comprising: (i) at least one stator having a plurality of wire windings that generate a magnetic field when an electric current is provided therethrough, (ii) a rotor comprising a spindle and configured to interact with the magnetic field to cause the spindle to rotate, and (iii) at least one cooling jacket comprising a channel;
providing a gearbox, wherein the gearbox comprises a gearbox housing and at least one gear disposed within the gearbox housing;
mounting the gearbox housing to the at least one cooling jacket of the electric motor;
extending the spindle of the rotor within the gearbox housing to engage and rotate the at least one gear of the gearbox as the spindle rotates, wherein the gearbox contains fluid, such that the fluid circulates from the gearbox through the channel of the at least one cooling jacket during operation of the electric motor; and
mounting a bearing at least partially within the gearbox housing such that the bearing supports the spindle.

20. The method of claim 19, wherein the at least one cooling jacket comprises: (i) an outer cooling jacket comprising the channel, and (ii) an inner cooling jacket comprising a respective channel, wherein the fluid of the gearbox circulates from the gearbox through the channel of the outer cooling jacket and through the respective channel of the inner cooling jacket, wherein mounting the gearbox housing to the at least one cooling jacket comprises:
mounting the gearbox housing to the outer cooling jacket.

21. The method of claim 19 wherein the bearing is a first bearing, wherein the electric motor further comprises an end plate mounted to the at least one cooling jacket, and wherein the method further comprises:
mounting a second bearing to the spindle and within the end plate to support the spindle.

22. The method of claim 19, wherein the bearing is a first bearing, wherein extending the spindle within the gearbox housing comprises extending the spindle through the gearbox housing such that the spindle protrudes outward from the gearbox housing, and wherein the method further comprises:
mounting a second bearing to the spindle outside the gearbox housing to facilitate mounting the gearbox and the electric motor to a structure while allowing the spindle to rotate relative to the structure.
